(19) United States
(12) Patent Application Publication
(10) Pub. No.: US 2025/0229278 A1
(43) Pub. Date: Jul. 17, 2025

(54) Fastening Element For a Lid

(71) Applicant: Grohe AG, Hemer (DE)

(72) Inventors: Michael Schulte, Menden (DE); Dominik Heubrock, Ascheberg (DE); Tobias Heine, Herdecke (DE)

(73) Assignee: Grohe AG, Hemer (DE)

(21) Appl. No.: 19/014,407

(22) Filed: Jan. 9, 2025

(30) Foreign Application Priority Data
Jan. 11, 2024 (DE) 102024100698.6

(51) Int. Cl. B05B 1/18; F16B 2/18

(52) U.S. Cl. CPC B05B 1/185; F16B 2/185

(57) ABSTRACT

A fastening element (1) for a lid (2) is proposed, having at least:
a first element (3), und
a second element (4) arranged on the first element (3) so as to be pivotable at least between a first position and a second position;

wherein in the first position, the second element (4) is arranged pretensioned by a stop (5) of the first element (3), wherein the stop (5) can be released by an elastic deformation of the first element (3), and the second element (4) can be pivoted towards the second position by at least partially reducing the pretension.

Two further configurations of a fastening element (1) are proposed.

The present invention relates to several different configurations of a fastening element for a lid, in particular for use in a sanitary device, wherein the sanitary device can be used in particular by persons in sanitary rooms, such as bathrooms, for showering, bathing and/or personal hygiene.

In sanitary devices, such as showers or bathtubs, large built-in ceiling shower heads (also referred to as built-in shower head) can be used, which have covers (covers, hereinafter also referred to as lids). As the only visible part of the ceiling shower head, the covers, on the one hand, cover the shower head components and concealed boxes located in the ceiling of a room and, on the other hand, they must meet high aesthetic requirements, as this type of shower head is usually a high-priced product in the premium segment. Visible fastening elements for the lid therefore represent an unacceptable visual disturbance. Permanent fixing of the lid is not permitted due to the need to be able to reach the shower components located behind it or covered by it. Due to manufacturing challenges, it is also necessary to manufacture these lids from sufficiently dimensionally stable materials such as metal, e.g., using a zinc die-casting method. Due to the high weight, a sufficiently secure and stable fixation of the lids is therefore important.

Fastening to the water-carrying functional assembly is also not possible, since a certain dynamic due to the water flow counteracts a stable connection.

Therefore, fixing the heavy lid (e.g., more than 500 grams) to a concealed box (which may be difficult to access, e.g., because it is arranged on a ceiling) or to a mounting plate must meet the following conditions:
secure fastening (i.e., cannot be detached independently);
invisible (i.e., not visible) fastening elements;
easy to mount; and
demountable (as well as remountable and demountable).

Known solutions for invisible connections are, e.g., magnets, clips, or snap-in hooks, but these are mechanically inadequate due to the high weight force. Other known connections such as screw connections (frontal, lateral) are generally undesirable because they are visible and therefore are an obstacle to aesthetic requirements.

It is therefore the object of the invention to at least partially solve the problems described with reference to the prior art and, in particular, to provide a fastening element for a lid which can be used in particular in sanitary devices and preferably for fastening lids to built-in ceiling shower heads.

These objects are achieved with a fastening element according to the features of the independent patent claims 1, 9 and 12. Further advantageous configurations of the invention are specified in the dependent patent claims. It should be noted that the features listed individually in the dependent patent claims can be combined with one another in any technologically meaningful manner and define further configurations of the invention. Moreover, the features specified in the patent claims are further specified and explained in the description, wherein further preferred configurations of the invention are shown.

A fastening element for a lid is proposed.

The fastening element and the lid can be used in particular in sanitary devices and are preferably suitable for built-in ceiling shower heads.

The fastening element (according to a first configuration) has at least:
a first element, and
a second element arranged on the first element so as to be pivotable at least between a first position and a second position.

In the first position, the second element is arranged pretensioned by a stop of the first element, wherein the stop can be released by elastic deformation of the first element, and the second element can be pivoted towards the second position by at least partially reducing the pretension.

The stop acts in a positive-locking manner with respect to the pivoting from the first position to the second position. In particular, due to a force acting in the direction of pivoting, releasing the stop (i.e., releasing the blocking effect of the stop, which prevents the second element from pivoting towards the second position) is not possible (at least not without additional plastic deformation of the first element).

In particular, the fastening element (according to the first configuration) has at least one energy storage element for generating the pretension. The energy storage element can be, for example, a tension spring, a compression spring, a spiral spring, a gas pressure accumulator, or another element that is elastically deformable and thereby stores the deformation energy.

In particular, the one of the elements has at least a first pin and the other one of the elements has a receptacle for the first pin. To produce the fastening element, the second element can be inserted into a recess of the first element along a first direction until the at least one first pin is arranged in the receptacle and thus an axis of rotation for pivoting the second element is formed.

In particular, one of the elements can be elastically deformed by the insertion, so that the at least one first pin engages in the receptacle.

In particular, the second element has the at least one first pin and the first element has the recess or the receptacle. In particular, the second element has two first pins.

In particular, the stop is formed by two stop elements, wherein each stop element is arranged on an extension of the first element, which can be elastically deformed to release the stop and can be moved away from each other in a spreading movement.

In particular, a direction of rotation of the pivoting runs perpendicular to the direction of the spreading movement of the extensions. In particular, the axis of rotation runs substantially parallel to the direction of the spreading movement.

In particular, the first direction runs transverse to the axis of rotation.

In particular, the stop blocks a pivoting of the second element from the second position back into the first position, at least in a non-positive manner. In particular, the non-positive blockade of the stop can therefore be overcome by an actuating force acting in the direction of the pivoting movement, wherein an at least partial plastic deformation of one of the elements does not occur in this case.

In particular, the second element can be pivoted from the second position into the first position by applying an actuating force acting on an actuating element of the second element and acting in a direction of rotation of the pivoting. In particular, the extensions are elastically deformed by the actuating force (if necessary to release the force-locking blockage of the stop) and thereby moved away from each other in the spreading movement. A surface of the second element that interacts with the stop elements or the extensions can be formed, e.g., as an inclined plane so that with increasing pivoting of the second element with respect to the first element, the extensions are spread further apart.

However, it is preferable that the stop elements only form the stop during the pivoting towards the second position and thus do not hinder the backward pivoting into the first position. This makes it possible, e.g., to detach the lid from the fastening elements by (only) overcoming the spring effect of the energy storage elements.

A fastening arrangement for a lid is further proposed. The fastening arrangement has at least:
a fastening plate;
a lid, and at least one of the described fastening elements (according to the first configuration) for fastening the lid to the fastening plate.

The fastening element (according to the first configuration) is fastened to the fastening plate via the first element (e.g., via rivet or screw connections). The lid has (at least) one projection, which elastically deforms the first element during a mounting process of the lid and thereby releases the stop, so that the second element, which is pretensioned in the first position, is pivoted with respect to the first element and forms a connection with the projection for fastening the lid to the fastening plate.

The fastening element (according to a second configuration) for a lid has at least:
a first element,
a second element arranged on the first element so as to be pivotable (and optionally additionally displaceable) at least between a first position and a second position, a third element arranged on the first element and (exclusively) displaceable with respect to the first element; and an energy storage element designed as a spring element.

When the third element is displaced, it contacts and pivots the second element, wherein the spring element is arranged between the first element and the second element in such a manner that pivoting the second element is carried out against a spring effect of the spring element.

In particular, the second element can be locked in the first position by the first element and in the second position by the third element.

Furthermore, a fastening arrangement for a lid is proposed. The fastening arrangement has at least:
a fastening plate;
a lid, and
at least one of the described fastening elements (according to the second configuration) for fastening the lid to the fastening plate.

The fastening element (according to the second configuration) is fastened to the fastening plate via the first element (e.g., via rivet or screw connections). The lid has (at least) one projection which contacts and displaces the third element during a mounting process of the lid so that the third element contacts the first element and pivots it into the second position, wherein in the second position, the second element forms a connection with the projection for fastening the lid to the fastening plate.

The fastening element (according to a third configuration) for a lid has at least:
a first element,
a second element arranged on the first element so as to be (exclusively) pivotable at least between a first position and a second position,
a third element arranged on the first element and (exclusively) displaceable with respect to the first element; and
an energy storage element designed as a spring element.

When the second element is pivoted, it contacts and displaces the third element, wherein the spring element is arranged between the first element and the third element in such a manner that the displacement of the third element is carried out against a spring effect of the spring element.

In particular, the second element is locked in the first position and in the second position by the third element.

Furthermore, a further fastening arrangement for a lid is proposed. The fastening arrangement has at least:
a fastening plate;
the lid, and
at least one of the described fastening elements (according to the third configuration) for fastening the lid to the fastening plate.

The fastening element (according to the third configuration) is fastened to the fastening plate via the first element (e.g., via rivet or screw connections). The lid has (at least) one projection which contacts the second element during a mounting process of the lid and pivots it into the second position, wherein in the second position, the second element forms a connection with the projection for fastening the lid to the fastening plate.

In particular, each of the fastening arrangements described additionally has at least one dispensing device for a liquid, the dispensing device being arranged between the fastening plate and the lid.

The dispensing device is connected, e.g., to a water-carrying supply line so that water can be dispensed via the dispensing device and through the lid to a user of the sanitary device. In particular, the dispensing device has a multiplicity of outlets through which the water can flow out of the dispensing device. In particular, each outlet of the dispensing device is associated with an opening in the lid so that the water can be dispensed from the dispensing device and via the respective opening to the user.

In particular, the fastening plate extends in a first plane and the lid extends in a second plane, wherein a plurality of fastening elements (according to the first and/or second and/or third configuration) arranged between the planes is provided, wherein the lid can be displaced along a mounting direction running transverse to the planes and, in doing so, in each case one projection can be connected to one fastening element.

In particular, each projection is associated in each case with one fastening element.

In particular, the projection contacts the extensions of the first element of the fastening element according to the first configuration and forces them (during the displacement of the lid along the mounting direction) into the spreading movement. This releases the blocking effect of the stop and the second element is pivoted from the first position into the second position. In particular, the second element interacts with the projection so that a connection is formed between the lid and fastening element that acts in a positive-locking manner with respect to the mounting direction.

In particular, the second element of the fastening element according to the first configuration interacts with the projection in such a manner that with increasing pivoting of the second element, the lid is displaced further in the mounting direction in the course of a lifting movement.

In the case of the fastening element according to the first configuration, the extensions deform back in the second position of the second element, in particular to such an extent that the stop elements form the non-positively acting stop, which prevents the backward pivoting towards the first position.

For this backward pivoting, it is particularly necessary for the second element to be actuated by an actuating force, so that the non-positive blockade of the stop can be overcome.

In the case of the fastening element according to the second configuration, the second element in particular is contacted by the third element (displaced by the projection) and pivoted from the first position to the second position.

In particular, a spring tension of the spring element is initially increased as a result of the pivoting. This is ensured by the position of the spring element and the engagement points thereof on the first element and the second element.

Alternatively, there is only a sliding movement between the first element (and the stop formed thereon) and the second element (and the first pin formed thereon and interacting with the stop); thus, there is no intermediate increase in the spring tension of the spring element.

In the case of fastening element according to the second configuration, the second element in particular has at least one first pin and the first element has an elongate first guide track, wherein the first pin extends into the first guide track. To produce the fastening element, the first element is designed in particular in two parts, wherein the second element and the third element (and optionally the spring element) are arranged between the halves of the first element.

The at least one first pin is arranged in the first guide track and thus forms an axis of rotation for pivoting the second element.

In particular, the third element is captively arranged on the first element and, in doing so, can only be displaced along one direction. The displaceability is implemented by second pins on the third element and second guide tracks on the first element, in which the second pins engage and through which they are guided.

In particular, during the pivoting into the second position, the locking of the second element, which takes place in the first position (and is effected by the first element), is first unlocked. In particular, in the course of the pivoting of the second element about the first pin (in the direction of rotation), a displacement of the first pin also takes place, as a result of which the increased spring tension of the spring element present in the first position is at least partially reduced.

The backward pivoting from the second position back to the first position is prevented by the third element, which is arranged displaced in the second position and contacts the second element.

For this backward pivoting, it is particularly necessary that the second element is actuated (thus, first displaced and then pivoted) via an actuating force so that the pretension can be overcome and the third element can be displaced.

In the case of fastening element according to the second configuration, the second element in particular is contacted by the third element (displaced by the projection) and pivoted from the first position to the second position.

In the case of fastening element according to the third configuration, in particular one of the first element and the second element has at least one first pin and the other one of the first element and the second element has a receptacle, wherein the first pin extends into the receptacle and forms an axis of rotation. To produce the fastening element, the first element is designed in particular in two parts, wherein the second element and the third element (and optionally the spring element) are arranged between the halves of the first element.

The at least one first pin is arranged in the receptacle and thus forms an axis of rotation for pivoting the second element.

In particular, when pivoting into the second position, the locking of the second element in the first position (and effected by the third element) is first released.

In particular, the second element has circumferential surfaces which extend at an angle to one another and are contacted by the pretensioned third element. When pivoting the second element, the second element is pivoted along the direction of rotation with respect to the first element and the third element. In doing so, the third element is displaced against the spring effect of the spring element and the contact between the second element and the third element is displaced to the circumferential surface closest in the direction of rotation (inclined at a different angle).

The backward pivoting from the second position back to the first position is prevented by the third element which contacts the second element arranged in the second position via a circumferential surface.

For this backward pivoting, it is in particular necessary that the second element is actuated by an actuating force (thus rotated exclusively in the direction of rotation) so that the pretension can be overcome and the third element can be displaced against the spring effect of the spring element.

The sanitary device is in particular a device for the personal hygiene of a person. For this purpose, the sanitary device can be designed, for example, like a shower or bathtub and/or be arranged in a sanitary room, such as a bathroom. The sanitary device can also be used for therapeutic applications. The sanitary device has at least one dispensing device for a liquid. The at least one dispensing device can in particular be a shower head, head shower head, built-in ceiling shower head, nozzle and/or outlet opening. A liquid, in particular water, can be dispensed into (at least) one basin of the sanitary device (the collection device) through at least one outlet of the dispensing device.

The basin or the collecting device can be designed in particular in the manner of a shower tray or a bathing basin. Furthermore, the basin can be arranged or fastened stationarily, for example on the floor of a building. In particular, the basin has a drain for the liquid. In particular, the liquid can be fed to a public sewer system via the drain.

The sanitary device also comprises, in particular, a thermostat (in a simplest embodiment, a mixing device without its own temperature control), by means of which hot water and cold water can be mixed to form a tempered mixed water. The hot water and the cold water are each fresh water and can be mixed by the thermostat to form mixed water with a desired mixed water temperature. A hot water temperature of the hot water can in particular be a maximum of 90° C. (degrees Celsius), preferably 25° C. to 90° C., particularly preferably 55° C. to 65° C., and/or a cold water temperature of the cold water can in particular be a maximum of 25° C. (degrees Celsius), preferably 1° C. to 25° C., particularly preferably 5°° C. to 20° C. The desired temperature of the liquid dispensed via the dispensing device can be, for example, 30° C. to 50° C., preferably 35° C. to 45° C., particularly preferably 35° C. to 40° C.

The hot water can be supplied to the thermostat, for example, from a hot water source, such as a boiler, a (private and/or local) thermal solar system or a heat pump, via a hot water pipe, and/or the cold water can be supplied from a cold water source, such as a building water connection, a public water supply network or a (private/local) well, via a cold water pipe. The hot water pipe and/or cold water pipe can be designed at least partially in the form of a pipeline. Furthermore, the hot water pipe and/or cold water pipe can run at least partially through a building wall and/or a building floor. The thermostat can have a hot water inlet for the hot water and/or a cold water inlet for the cold water. The hot water line can be connected to the hot water inlet, and/or the cold water line can be connected to the cold water inlet. In addition, the thermostat can be arranged at least partially in the building wall or the building floor.

The mixed water line can be designed at least partially in the manner of a pipe and/or hose line and fluidically connected to the dispensing device.

The desired temperature of the liquid dispensed via the dispensing device can be adjusted by a user of the sanitary device, for example, via an actuating element of the sanitary device and/or the thermostat.

The use of indefinite articles (“a”, and “an”), in particular in the patent claims and the description reproducing them, is to be understood as such and not as a number word. Accordingly, terms or components introduced therewith are to be understood as being present at least once and, in particular, can also be present more than once.

As a precaution, it should be noted that the number words used here (“first”, “second”, . . . ) primarily serve (only) to differentiate between several similar objects, quantities, or processes, i.e., in particular, they do not necessarily specify any dependency and/or sequence of these objects, quantities or processes in relation to one another. If a dependency and/or sequence is required, this is explicitly stated here or is obvious to the person skilled in the art when studying the specific configuration described. Insofar as a component may occur more than once (“at least one”), the description of one of these components may apply equally to all or some of the plurality of these components, but this is not mandatory.

The invention and the technical context are explained in more detail below with reference to the accompanying figures. It should be noted that the invention is not intended to be limited by the exemplary embodiments given. In particular, it should be noted that the figures and in particular the proportions shown are only schematic. In the figures:

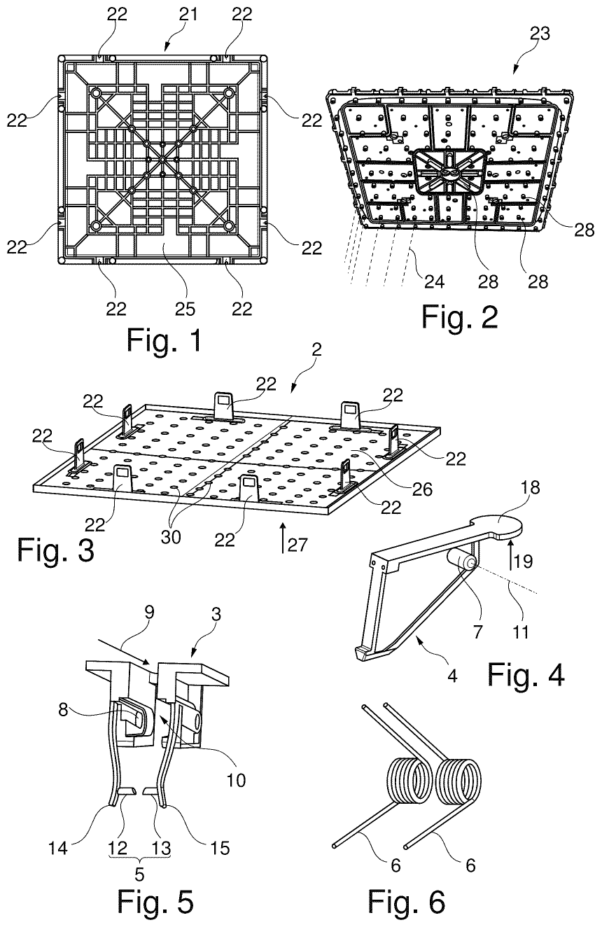

FIG. 1: shows a fastening plate in a plan view;

FIG. 2: shows a dispensing device in a perspective view;

FIG. 3: shows a lid in a perspective view;

FIG. 4: shows a second element of a fastening element according to a first embodiment variant in a perspective view;

FIG. 5: shows a first element of a fastening element according to a first embodiment variant of a fastening element according to a first embodiment variant in a perspective view;

FIG. 6: shows two energy storage elements of a fastening element according to a first embodiment variant in a perspective view;

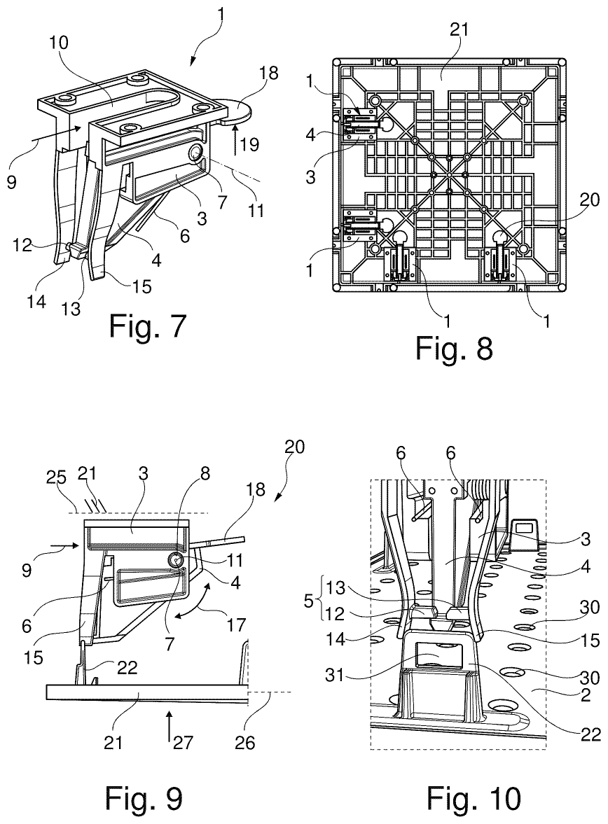

FIG. 7: shows a fastening element according to a first embodiment variant in a perspective view;

FIG. 8: shows a fastening arrangement with a plurality of fastening elements according to a first embodiment variant in a plan view;

FIG. 9: shows a detail of the fastening arrangement according to FIG. 8 in a side view, with the fastening element in a first position;

FIG. 10: shows a perspective view of the detail according to FIG. 9;

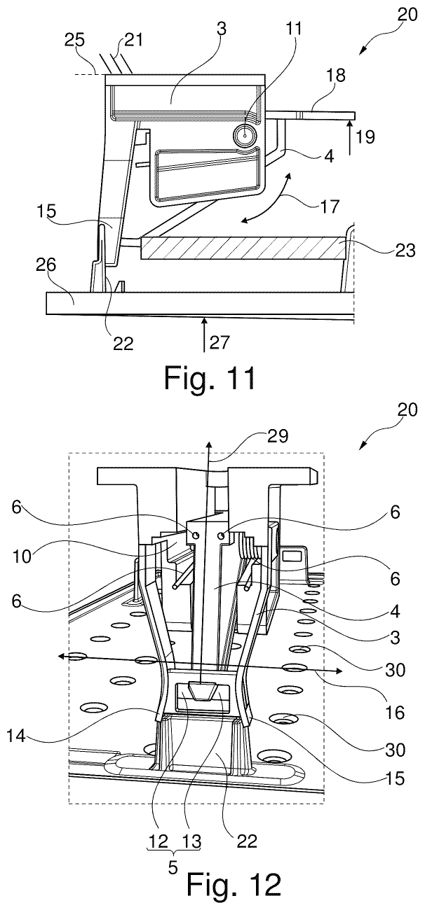

FIG. 11: shows a detail of the fastening arrangement according to FIG. 8 in a side view, with the fastening element in a second position;

FIG. 12: shows a perspective view of the detail according to FIG. 12;

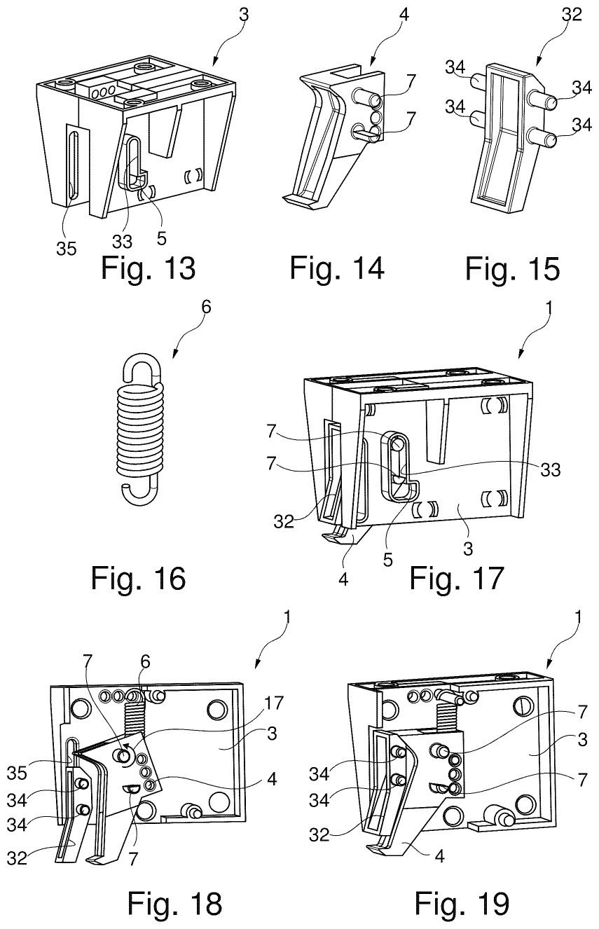

FIG. 13: shows a first element of a fastening element according to a second embodiment variant;

FIG. 14: shows a second element of a fastening element according to a second embodiment variant in a perspective view;

FIG. 15: shows a third element of a fastening element according to a second embodiment variant in a perspective view;

FIG. 16: shows a spring element of a fastening element according to a second embodiment variant in a perspective view;

FIG. 17: shows a fastening element according to a second embodiment variant in a perspective view;

FIG. 18: shows the fastening element according to FIG. 17 in a perspective, sectional view;

FIG. 19: shows the fastening element according to FIGS. 17 and 18 in a further perspective, sectional view;

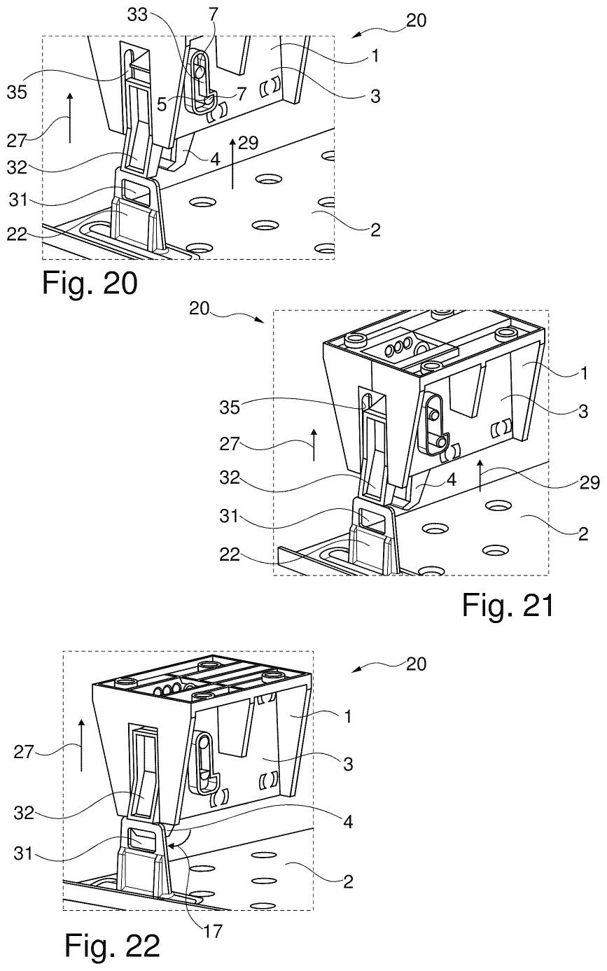

FIG. 20: shows a fastening arrangement with a fastening element according to a second embodiment variant in a perspective view, with the fastening element in a first position;

FIG. 21: shows the fastening arrangement according to FIG. 20, with the fastening element in an intermediate position between the first and the second position;

FIG. 22: shows the fastening arrangement according to FIGS. 20 and 21, with the fastening element in a second position;

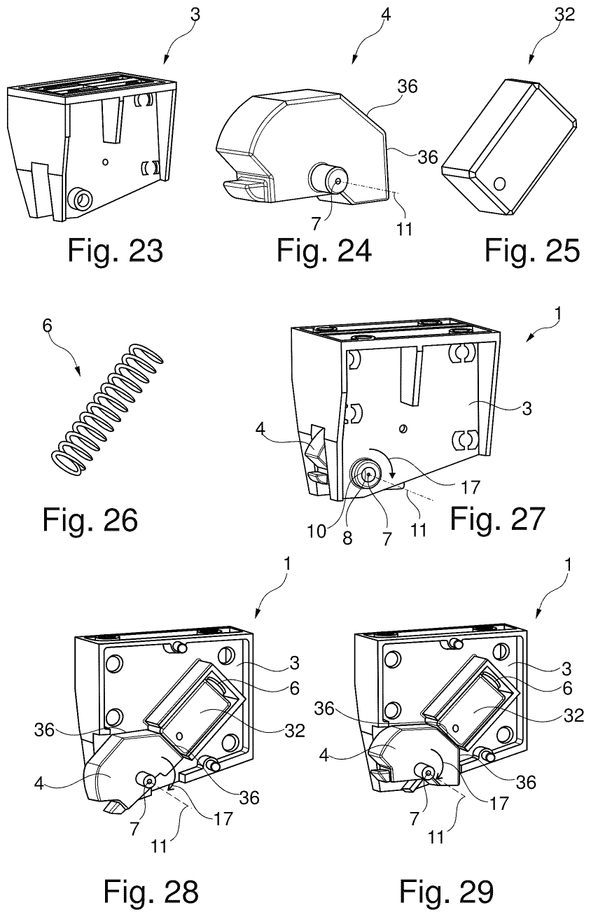

FIG. 23: shows a first element of a fastening element according to a third embodiment variant;

FIG. 24: shows a second element of a fastening element according to a third embodiment variant in a perspective view;

FIG. 25: shows a third element of a fastening element according to a third embodiment variant of a fastening element in a perspective view;

FIG. 26: shows a spring element of a fastening element according to a third embodiment variant in a perspective view;

FIG. 27: shows a fastening element according to a third embodiment variant in a perspective view;

FIG. 28: shows the fastening element according to FIG. 27 in a perspective, sectional view;

FIG. 29: shows the fastening element according to FIGS. 27 and 28 in a further perspective, sectional view;

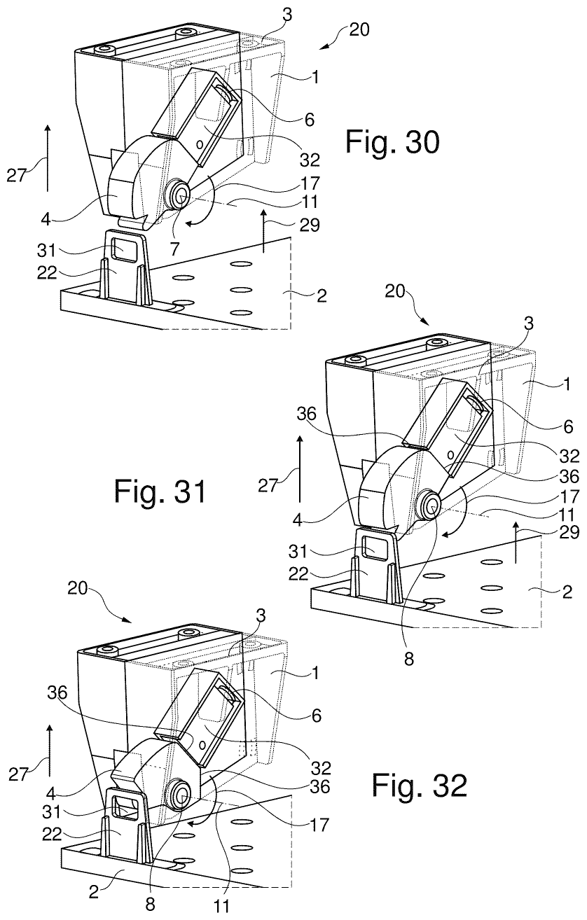

FIG. 30: shows a fastening arrangement with a fastening element according to a third embodiment variant in a perspective view, with the fastening element in a first position;

FIG. 31: shows the fastening arrangement according to FIG. 30, with the fastening element in an intermediate position between the first and second position; and

FIG. 32: shows the fastening arrangement according to FIGS. 30 and 31, with the fastening element in a second position.

FIG. 1 shows a fastening plate 21 in a plan view. FIG. 2 shows a dispensing device 23 in a perspective view. FIG. 3 shows a lid 2 in a perspective view. FIG. 4 shows a second element 4 of a fastening element 1 according to a first embodiment variant in a perspective view. FIG. 5 shows a first element 3 of a fastening element 1 according to a first embodiment variant in a perspective view. FIG. 6 shows two energy storage elements 6 of a fastening element 1 according to a first embodiment variant in a perspective view. FIG. 7 shows a fastening element 1 according to a first embodiment variant in a perspective view. FIG. 8 shows a fastening arrangement 20 in a plan view. FIGS. 1 to 8 are described together below.

The fastening arrangement 20 for a lid 2 comprises a fastening plate 21, a lid 2 and a plurality of fastening elements 1 for fastening the lid 2 to the fastening plate 21.

The fastening element 1 according to a first embodiment variant (corresponding to the first configuration) comprises a first element 3 and a second element 4 arranged on the first element 3 to be pivotable at least between a first position (see FIGS. 9 and 10) and a second position (see FIGS. 11 and 12).

In the first position, the second element 4 is pretensioned by a stop 5 of the first element 3, wherein the stop 5 can be released by an elastic deformation of the first element 3 and the second element 4 can be pivoted towards the second position by at least partially reducing the pretension.

The stop 5 acts in a positive-locking manner with respect to the pivoting from the first position to the second position. Due to a force acting in the direction of the pivoting (e.g., an actuating force 19), releasing the stop 5, i.e., releasing the blocking effect of the stop 5, which prevents the second element 4 from pivoting towards the second position, is not possible. At the very least, the release of the blocking effect is not possible without plastic deformation of the first element 3.

The fastening element 1 has two springs as energy storage elements 6 for generating the pretension. The springs are designed as spiral springs, with one end of the spiral spring being supported on the first element 3 and the other end on the second element 4.

The second element has two first pins 7. The first element 3 has a receptacle 8 for each first pin 7. To produce the fastening element 1, the second element 4 can be inserted into a recess 10 of the first element 3 along a first direction 9 (see, for example, FIGS. 5, 7 and 9) until the first pins 7 are arranged in the respective receptacle 8 and thus an axis of rotation 11 is formed for pivoting the second element 4.

Due to the insertion, the first element 3 can be at least partially elastically deformed, so that the first pins 7 can engage in the respective recess 8.

The stop 5 is formed by two stop elements 12, 13, each stop element 12, 13 being arranged on an extension 14, 15 of the first element 3, which are elastically deformable to release the stop 5 and can be moved away from each other in a spreading movement 16 (see FIG. 12).

A direction of rotation 17 of the pivoting runs perpendicular to the direction of the spreading movement 16 of the extensions 14, 15. The axis of rotation 11 runs substantially parallel to the direction of the spreading movement 16. The first direction 9 runs transverse to the axis of rotation 11.

The stop 5 blocks a pivoting movement of the second element 4 from the second position back into the first position at least (exclusively) in a non-positive manner. In particular, the non-positive blocking of the stop 5 can therefore be overcome by an actuating force 19 acting in the direction of the pivoting, wherein an at least partial plastic deformation of one of the elements 3, 4 does not occur in the process of this (see description of FIGS. 11 and 12 below).

The second element 4 can be pivoted from the second position into the first position by applying an actuating force 19 (see FIG. 7) acting on an actuating element 18 of the second element 4 and acting in a direction of rotation 17 of the pivoting, wherein the extensions 14, 15 can be elastically deformed by the actuating force 19 to release the non-positive blockade of the stop 5 and can be moved away from each other in the spreading movement 16. Here, a surface of the second element 4 interacting with the stop elements 12, 13 or the extensions 14, 15 can be designed, e.g., as an inclined plane, so that with increasing pivoting of the second element 4 with respect to the first element 3, the extensions 14, 15 are spread further apart.

The fastening element 1 is attached to the fastening plate 21 via the first element 3 (e.g., via rivet or screw connections). The lid 2 has a plurality of projections 22, which elastically deform the respective first element 3 (or its extensions 14, 15) during a mounting process of the lid 2 and thereby release the stop 5, so that the second element 4, which is arranged pretensioned in the first position, is pivoted with respect to the first element 3 and forms a connection with the projection 22 for fastening the lid 2 to the fastening plate 21.

The fastening arrangement 20 additionally has a dispensing device 23 for a liquid 24, wherein the dispensing device 23 is arranged between the fastening plate 21 and the lid 2.

The dispensing device 23 is connected, e.g., to a water-carrying supply line, so that water (liquid 24) can be dispensed via the dispensing device 23 and through the lid 2 to a user of the sanitary device. The dispensing device 23 has a multiplicity of outlets 28 through which the liquid 24 can flow out of the dispensing device 23. Each outlet 28 of the dispensing device 23 is associated with an opening 30 in the lid 2, so that the liquid 24 can be dispensed from the dispensing device 23 and via the respective opening 30 towards the user.

The fastening plate 21 extends in a first plane 25 and the lid 2 in a second plane 26, wherein a plurality of fastening elements 1 arranged between the planes 25, 26 is provided, wherein the lid 2 can be displaced along a mounting direction 27 running transverse to the planes 25, 26, and in each case one projection 22 can be connected to a fastening element 1 (this also applies to the second and third embodiment variants). Each projection 22 is associated with a fastening element 1.

FIG. 9 shows a detail of the fastening arrangement 20 according to FIG. 8 in a side view, with the fastening element 1 in a first position. FIG. 10 shows a perspective view of the detail according to FIG. 9. FIG. 11 shows a detail of the fastening arrangement 20 according to FIG. 8 in a side view, with the fastening element 1 in a second position. FIG. 12 shows a perspective view of the detail according to FIG. 12. FIGS. 9 to 12 are described together below. Reference is made to the explanations of FIGS. 1 to 8.

In FIGS. 9 and 10, the fastening arrangement 20 is shown before the connection between the projection 22 and the fastening element 1 is made. The fastening element 1 according to the first embodiment variant is fastened to the fastening plate 21 via the first element 3 (e.g., via rivet or screw connections, not shown). The lid 2 has a projection 22 which elastically deforms the respective first element 3 or its extensions 14, 15 during the mounting process of the lid 2, so that these are moved away from each other in the course of the spreading movement 16. As a result of this spreading movement 16, which is forced by the lateral edges of the projection 22, the stop elements 12, 13 are also moved away from each other in the course of the spreading movement 16, so that the stop 5 is released. This allows the second element 4, which is pretensioned in the first position by the energy storage elements 6, to pivot with respect to the first element 3 and form a connection with the projection 22 for fastening the lid 2 to the fastening plate 21. The connection with the projection 22 is made via a latching hook connection, in which the second element 4 forms a positive connection with a window 31 in the projection 22 with respect to the mounting direction 27 (see FIG. 12). The second element 4 interacts with the projection 22 in such a manner that with increasing pivoting of the second element 4, the lid 2 is displaced further in the mounting direction 27 towards the fastening plate 21 in the course of a lifting movement 29.

In FIGS. 11 and 12, the fastening arrangement 20 is shown after the connection between the projection 22 and the fastening element 1 has been established in accordance with the first embodiment variant. The connection with the projection 22 via the latching hook connection, in which the second element 4 forms the positive connection with the window 31 in the projection 22 with respect to the mounting direction 27, is established.

In doing so, a backward pivoting towards the first position can be hindered by the elastically deformed extensions 14, 15 when the stop elements 12, 13 again form the stop 5. For this purpose, the second element 4 can be shaped accordingly so that the extensions 14, 15 can pivot back far enough so that the stop elements 12, 13 form the stop 5 for the second element 4 in order to prevent pivoting of the second element in the direction of rotation 17 towards the first position.

The stop 5 then blocks a pivoting of the second element 4 from the second position back into the first position, at least in a non-positive manner. In doing so, the non-positive blocking of the stop 5 can only be overcome by a sufficiently high actuating force 19 acting in the direction of the pivoting, wherein an at least partial plastic deformation of one of the elements 3, 4 does not occur. Acting on the second element 4 by means of the actuating force 19 is carried out, e.g., via a tool that engages on the actuating element 18 (see FIG. 11).

The second element 4 can be pivoted from the second position into the first position by applying the actuating force 19 acting on an actuating element 18 of the second element 4 and acting in a rotational direction 17 of the pivoting, wherein the extensions 14, 15 can be elastically deformed by the actuating force 19 to release the non-positive blockage of the stop 5 and can be moved away from each other (again) in the spreading movement 16. In this case, a surface of the second element 4 interacting with the stop elements 12, 13 or the extensions 14, 15 can be designed, e.g., as an inclined plane, so that with increasing pivoting of the second element 4 with respect to the first element 3, the extensions 14, 15 are spread further apart.

However, it is preferable that the stop elements 12, 13 only form the stop 5 during the pivoting towards the second position and thus do not hinder the backward pivoting into the first position. This makes it possible, e.g., to detach the lid 2 from the fastening elements 1 by (only) overcoming the spring effect of the energy storage elements 6.

The proposed fastening element 1 allows secure and repeatedly detachable fastening of the lid 2 to a fastening plate 21 (e.g., a concealed box), wherein in particular the fastening element 1 as a means of fastening the lid 2 remains invisible to a user of the sanitary device.

FIG. 13 shows a first element 3 of a fastening element 1 according to a second embodiment variant. FIG. 14 shows a second element 4 of a fastening element 1 according to a second embodiment variant in a perspective view. FIG. 15 shows a third element 32 of a fastening element 1 according to a second embodiment variant in a perspective view. FIG. 16 shows a perspective view of an energy storage element 6 designed as a spring element of a fastening element 1 according to a second embodiment variant. FIG. 17 shows a fastening element 1 according to a second embodiment variant (in the second position) in a perspective view. FIG. 18 shows the fastening element 1 according to FIG. 17 in a perspective, sectional view in the first position. FIG. 19 shows the fastening element 1 according to FIGS. 17 and 18 (in the second position) in another perspective, sectional view. FIG. 20 shows a fastening arrangement 20 with a fastening element 1 according to a second embodiment variant in a perspective view, with the fastening element 1 in a first position. FIG. 21 shows the fastening arrangement 20 according to FIG. 20, with the fastening element 1 in an intermediate position between the first and the second position. FIG. 22 shows the fastening arrangement 20 according to FIGS. 20 and 21, with the fastening element 1 in a second position. FIGS. 13 to 22 are described together below. Reference is made to the explanations of FIGS. 1 to 12.

The fastening element 1 according to the second embodiment variant (corresponds to the second configuration) for a lid 2 has a first element 3, a second element 4 arranged on the first element 3 so as to be pivotable between a first position (see FIG. 17) and a second position (see FIG. 19), a third element 32 arranged on the first element 3 and (only) displaceable with respect to the first element 3, and an energy storage element 6 designed as a spring element.

In the case of the fastening element 1 according to the second embodiment variant, the second element 4 is contacted by the third element 32 displaced by the projection 22 of the lid 2 (see FIG. 20) and pivoted from the first position into the second position (see FIG. 21 and FIG. 22). In doing so, the stop 5 is first overcome in the course of a sliding movement between stop 5 and first pin 7 (see FIGS. 18 and 19).

The third element 32 is captively arranged on the first element 3 and can only be moved in one direction. The displaceability is implemented by second pins 34 on the third element 32 and second guide tracks 35 on the first element 3.

In the case of the fastening element 1 according to the second embodiment variant, the second element 4 has two first pins 7 and the first element 3 has two elongate first guide tracks 33, with each first pin 7 extending into the respective first guide track 33. To produce the fastening element 1, the first element 3 is made in two parts, with the second element 4 and the third element 32 as well as the spring element 6 being arranged between the halves of the first element 3.

The first pins 7 are arranged in the first guide tracks 33 and thus form an axis of rotation 11 for pivoting the second element 4. When pivoting into the second position, the locking of the second element 4 in the first position (and effected by the first element 3) is first released. This locking is implemented by an interaction between the correspondingly shaped first guide track 33 and a stop 5 (another first pin on the second element 4) (see FIGS. 20 and 22). In the course of the pivoting of the second element 4 about the first pin 7 (in the direction of rotation 17), a displacement of the second element 4 and thus of the first pin 7 is also carried out, wherein the spring element's 6 increased spring tension in the first position is at least partially reduced as a result.

The backward pivoting from the second position back into the first position is prevented by the third element 32, which is arranged displaced in the second position with respect to the first position and contacts the second element 4. In doing so, the third element 32 is locked in this displaced position by the projection 22 of the lid 2 (see FIG. 22).

The backward pivoting into the first position makes it necessary for the second element 4 to be actuated (i.e., first displaced and then pivoted) via an actuating force, so that the pretension can be overcome and the third element 32 can be displaced. The movement of the second element 4 during the backward pivoting of the second element 4 is determined by the shape of the first guide tracks 33 in which the first pins 7 are guided.

In the case of the fastening element 1 according to the second configuration, the second element 4 is contacted by the third element 32 (displaced by the projection 22) and pivoted and displaced from the first position to the second position. In doing so, a spring tension of the spring element 6 is initially increased as a result of the pivoting. This is ensured by the position of the spring element 6 and its points of engagement on the first element 3 and the second element 4 (see FIGS. 18 and 19).

If the third element 32 is displaced, it contacts and pivots the second element 4, wherein the spring element 6 is arranged between the first element 3 and the second element 4 in such a manner that the pivoting of the second element 4 takes place against a spring effect of the spring element 6.

The second element 4 is locked in the first position by the first element 3 (and the stop 5) and in the second position by the third element 32.

The fastening arrangement 20 for a lid 2 shown in FIGS. 20 to 22 has a fastening plate 21 (not shown, cf. FIGS. 1 and 8), a lid 2 and a plurality (not shown) of one of the described fastening elements 1 according to the second embodiment variant for fastening the lid 2 to the fastening plate 21. The fastening element 1 is fastened to the fastening plate 21 via the first element 3 (e.g., via rivet or screw connections). The lid 2 has a projection 22 which contacts and displaces the third element 32 in the course of a mounting process of the lid 2, so that the third element 32 contacts the second element 4 and pivots it into the second position, wherein the second element 4 forms a connection with the projection 22 in the second position for fastening the lid 2 to the fastening plate 21 (FIG. 22).

The connection with the projection 22 is made via a latching hook connection, in which the second element 4 forms a positive connection with a window 31 in the projection 22 with respect to the mounting direction 27 (see FIG. 22). The third element 32 interacts with the projection 22 in such a manner that, after the second element 4 has been pivoted, the lid 2 is displaced further in the mounting direction 27 towards the fastening plate 21 in the course of a lifting movement 29 until the latching hook connection is formed.

FIG. 23 shows a first element 3 of a fastening element 1 according to a third embodiment variant. FIG. 24 shows a second element 4 of a fastening element 1 according to a third embodiment variant in a perspective view. FIG. 25 shows a third element 32 of a fastening element 1 according to a third embodiment variant in a perspective view. FIG. 26 shows a perspective view of an energy storage element 6 designed as a spring element of a fastening element 1 according to a third embodiment variant. FIG. 27 shows a fastening element 1 according to a third embodiment variant (in the second position) in a perspective view. FIG. 28 shows the fastening element 1 according to FIG. 27 in a perspective, sectional view in the first position. FIG. 29 shows the fastening element 1 according to FIGS. 27 and 28 (in the second position) in a further perspective, sectional view. FIG. 30 shows a fastening arrangement 20 with a fastening element 1 according to a third embodiment variant in a perspective view, with the fastening element 1 in a first position. FIG. 31 shows the fastening arrangement 20 according to FIG. 30, with the fastening element 1 in an intermediate position between the first and the second position. FIG. 32 shows the fastening arrangement 20 according to FIGS. 30 and 31, with the fastening element 1 in a second position. FIGS. 23 to 32 are described together below. Reference is made to the explanations of FIGS. 1 to 12 and 13 to 22.

The fastening element 1 according to the third embodiment variant (corresponds to the third configuration) for a lid 2 has a first element 3, a second element 4 arranged on the first element 3 so as to be pivotable between a first position (see FIG. 28) and a second position (see FIG. 29), a third element 32 arranged on the first element 3 and displaceable with respect to the first element 3, and an energy storage element 6 designed as a spring element.

When the second element 4 is pivoted, it contacts and displaces the third element 32, wherein the spring element 6 is arranged between the first element 3 and the third element 32 in such a manner that the displacement of the third element 32 is carried out against a spring effect of the spring element 6.

The second element 4 is locked in the first position and in the second position by the third element 32.

In the case of the fastening element 1 according to the third embodiment variant, the second element 4 has two first pins 7 arranged coaxially to one another, and the first element 3 has correspondingly shaped recesses 10, wherein each first pin 7 extends in each case into one recess 10 and forms an axis of rotation 11. To produce the fastening element 1, the first element 3 is made in two parts, wherein the second element 4 and the third element 32 as well as the spring element are captively arranged between the halves of the first element 3.

The first pins 7 are arranged in the respective recess 10 and thus form an axis of rotation 11 for pivoting the second element 4 with respect to the first element 3. When pivoting into the second position, the locking of the second element 4 provided in the first position and effected by the third element 32 is first released.

The second element 4 has circumferential surfaces 36 which extend at an angle to one another and which are contacted by the pretensioned third element 32. When the second element 4 is pivoted, the second element 4 is pivoted along the direction of rotation 17 with respect to the first element 3 and the third element 32. In doing so, the third element 32 is displaced against the spring effect of the spring element 6 and the contact between the second element 4 and the third element 32 is displaced to the circumferential surface 36 closest in the direction of rotation 17 (inclined at a different angle).

The backward pivoting from the second position back to the first position is prevented by the third element 32 which contacts the second element 4 arranged in the second position via a circumferential surface 36.

For this backward pivoting, it is necessary for the second element 4 to be actuated by an actuating force (i.e., rotated in the direction of rotation 17), so that the pretension can be overcome and the third element 32 can be displaced against the spring effect of the spring element 6.

The fastening arrangement 20 for a lid 2 shown in FIGS. 30 to 32 has a fastening plate 21 (not shown, cf. FIGS. 1 and 8), a lid 2 and a plurality (not shown) of one of the described fastening elements 1 according to the third embodiment variant for fastening the lid 2 to the fastening plate 21. The fastening element 1 is fastened to the fastening plate 21 via the first element 3 (e.g., via rivet or screw connections). The lid 2 has a projection 22, which contacts and pivots the second element 4 in the course of a mounting process of the lid 2. During the pivoting of the second element 4, it contacts and displaces the third element 32, wherein the spring element is arranged between the first element 3 and the third element 32 in such a manner that the displacement of the third element 32 is carried out against a spring effect of the spring element 6. In the second position, the second element 4 forms a connection with the projection 22 for fastening the lid 2 to the fastening plate 21 (FIG. 32).

The connection with the projection 22 is made via a latching hook connection, in which the second element 4 forms a positive connection with a window 31 in the projection 22 with respect to the mounting direction 27 (see FIG. 32). In doing so, the second element 4 interacts with the projection 22 in such a manner that with increasing pivoting of the second element 4, the lid 2 is displaced further in the mounting direction 27 towards the fastening plate 21 in the course of a lifting movement 29.

### Reference List

1 fastening element
2 lid
3 first element
4 second element
5 stop
6 energy storage element/spring element
7 first pin
8 receptacle
9 first direction
10 recess
11 axis of rotation
12 first stop element
13 second stop element
14 first extension
15 second extension
16 spreading movement
17 direction of rotation
18 actuating element
19 actuating force
20 fastening arrangement
21 fastening plate
22 projection
23 dispensing device
24 liquid
25 first plane
26 second plane
27 mounting device
28 outlet
29 lifting movement
30 opening
31 window
32 third element
33 first guide track
34 second pin
35 second guide track
36 circumferential surface

1. A fastening element (1) for a lid (2), comprising:
a first element (3) and
a second element (4) arranged on the first element (3) so as to be pivotable at least between a first position and a second position;
wherein
in the first position, the second element (4) is arranged pretensioned by a stop (5) of the first element (3), wherein the stop (5) is configured to be released by an elastic deformation of the first element (3), and the second element (4) is configured to be pivoted towards the second position by at least partially reducing the pretension.

2. The fastening element (1) according to claim 1, comprising at least one energy storage element (6) for generating the pretension.

3. The fastening element (1) according to claim 1, wherein the one of the elements (3, 4) has at least one first pin (7) and the other one of the elements (4, 3) has a receptacle (8) for the first pin (7); wherein for producing the fastening element (1), the second element (4) is configured to be inserted along a first direction (9) into a recess (10) of the first element (3) until the at least one first pin (7) is arranged in the receptacle (8) and an axis of rotation (11) for pivoting the second element (4) is thus formed.

4. The fastening element (1) according to claim 1, wherein the stop (5) is formed by two stop elements (12, 13), wherein each stop element (12, 13) is arranged on an extension (14, 15) of the first element (3), which are elastically deformable to release the stop (5) and, in doing so, is configured to be moved away from each other in a spreading movement (16).

5. The fastening element (1) according to claim 4, wherein a direction of rotation (17) of the pivoting runs perpendicular to the direction of the spreading movement (16) of the extensions (14, 15).

6. The fastening element (1) according to claim 4, wherein the stop (5) blocks a pivoting of the second element (4) from the second position back into the first position at least in a non-positive manner.

7. The fastening element (1) according to claim 6, wherein the second element (4) is configured to be pivoted from the second position into the first position by application of an actuating force (19) acting on an actuating element (18) of the second element (4) and acting in a direction of rotation (17) of the pivoting, wherein the extensions (14, 15) are configured to be elastically deformed by the actuating force (19) to release the non-positive blocking of the stop (5) and, in doing so, are configured to be moved away from each other in the spreading movement (16).

8. A fastening arrangement (20) for a lid (2), comprising:
a fastening plate (21);
the lid (2), and
at least one fastening element (1) according to claim 1 for fastening the lid (2) to the fastening plate (21);
wherein
the fastening element (1) is fastened to the fastening plate (21) via the first element (3), wherein the lid (2) has a projection (22) which, in the course of a mounting process of the lid (2), elastically deforms the first element (3) and thereby releases the stop (5) so that the second element (4) arranged pretensioned in the first position is pivoted with respect to the first element (3) and forms a connection with the projection (22) for fastening the lid (2) to the fastening plate (21).

9. A fastening element (1) for a lid (2), comprising:
a first element (3),
a second element (4) arranged on the first element (3) so as to be pivotable at least between a first position and a second position; and
a third element (32) arranged on the first element (3) and displaceable with respect to the first element (3);
wherein
the third element (32) contacts and pivots the second element (4) during a displacement, wherein the spring element (6) is arranged between the first element (3) and the second element (4) in such a manner that the pivoting of the second element (4) is carried out against a spring effect of the spring element (6).

10. The fastening element (1) according to claim 9, wherein the second element (4) is configured to be locked in the first position by the first element (3) and in the second position by the third element (32).

11. A fastening arrangement (20) for a lid (2), comprising:
a fastening plate (21);
the lid (2), and
at least one fastening element (1) according to claim 9 for fastening the lid (2) to the fastening plate (21);
wherein
the fastening element (1) is fastened to the fastening plate (21) via the first element (3), wherein the lid (2) has a projection (22) which contacts and displaces the third element (32) in the course of a mounting process of the lid (2) so that the third element (32) contacts the first element (3) and pivots it into the second position, wherein in the second position, the second element (4) forms a connection with the projection (22) for fastening the lid (2) to the fastening plate (21).

12. A fastening element (1) for a lid (2), comprising:
a first element (3),
a second element (4) arranged on the first element (3) so as to be pivotable at least between a first position and a second position;
a third element (32) arranged on the first element (3) and displaceable with respect to the first element; and
an energy storage element (6) designed as a spring element;
wherein
the second element (4) contacts and displaces the third element (32) during pivoting;
wherein the spring element (6) is arranged between the first element (3) and the second element (4) in such a manner that the pivoting of the second element (4) is carried out against a spring effect of the spring element (6); wherein the spring element (6) is arranged between the first element (3) and the third element (32) in such a manner that the displacement of the third element (32) is carried out against a spring effect of the spring element (6).

13. The fastening element (1) according to claim 12, wherein the second element (4) is locked in the first position and in the second position by the third element (32).

14. A fastening arrangement (20) for a lid (2) comprising:
a fastening plate (21);
the lid (2), and
at least one fastening element (1) according to claim 12 for fastening the lid (2) to the fastening plate (21);
wherein the fastening element (1) is fastened to the fastening plate (21) via the first element (3), wherein the lid (2) has a projection (22) which contacts the second element (4) in the course of a mounting process of the lid (2) and pivots it into the second position, wherein in the second position, the second element (4) forms a connection with the projection (22) for fastening the lid (2) to the fastening plate (21).

15. The fastening arrangement (20) according to claim 8, comprising at least one dispensing device (23) for a liquid (24), which is arranged between the fastening plate (21) and the lid (2).

16. The fastening arrangement (20) according to claim 8, wherein the fastening plate (21) extends in a first plane (25) and the lid (2) extends in a second plane (26), wherein a plurality of fastening elements (1) arranged between the planes (25, 26) is provided, wherein the lid (2) is configured to be displaced along a mounting direction (27) running transverse to the planes (25, 26) and, in doing so, in each case one projection (22) is configured to be connected to a fastening element (1).

17. The fastening arrangement (20) according to claim 11, comprising at least one dispensing device (23) for a liquid (24), which is arranged between the fastening plate (21) and the lid (2).

18. The fastening arrangement (20) according to claim 14, comprising at least one dispensing device (23) for a liquid (24), which is arranged between the fastening plate (21) and the lid (2).

19. The fastening arrangement (20) according to claim 14, wherein the fastening plate (21) extends in a first plane (25) and the lid (2) extends in a second plane (26), wherein a plurality of fastening elements (1) arranged between the planes (25, 26) is provided, wherein the lid (2) is configured to be displaced along a mounting direction (27) running transverse to the planes (25, 26) and, in doing so, in each case one projection (22) is configured to be connected to a fastening element (1).

20. The fastening arrangement (20) according to claim 15, wherein the fastening plate (21) extends in a first plane (25) and the lid (2) extends in a second plane (26), wherein a plurality of fastening elements (1) arranged between the planes (25, 26) is provided, wherein the lid (2) is configured to be displaced along a mounting direction (27) running transverse to the planes (25, 26) and, in doing so, in each case one projection (22) is configured to be connected to a fastening element (1).
